(19) United States
(12) Patent Application Publication
(10) Pub. No.: US 2019/0000194 A1
(43) Pub. Date: Jan. 3, 2019

(54) ADJUSTABLE LINKAGE AND AN ASSOCIATED WEARABLE ACCESSORY HAVING A PLURALITY OF INTERCONNECTED LINKS WITH TOOLS

(71) Applicant: Leatherman Tool Group, Inc., Portland, OR (US)

(72) Inventors: Adam LAZENBY, Lake Oswego, OR (US); Zach HEISE, Portland, OR (US); James David BUCKROYD, Portland, OR (US); Lucy Emma DAVIS, Portland, OR (US)

(21) Appl. No.: 15/636,032

(22) Filed: Jun. 28, 2017

(51) Int. Cl. A44C 5/02; A44C 5/00; A44C 5/24; A44C 15/00; A41F 9/00; B67B 7/16; B25B 15/00; B25F 1/04

(52) U.S. Cl. CPC A44C 5/027; A44C 5/003; A44C 5/24; A44C 5/0069; A44C 15/005; B25F 1/04; A41F 9/002; B67B 7/16; B25B 15/007; B25B 15/005; B25B 15/008; A44C 15/0085

(57) ABSTRACT

A wearable accessory is provided along with an adjustable linkage and a functional element. In regards to the adjustable linkage, the adjustable linkage includes first and second linkage portions spaced apart from one another to define a channel therebetween. Each linkage portion includes a sidewall defining first and second openings. The second opening defined by each linkage portion includes a plurality of holes spaced in a longitudinal direction to provide sizing options. The adjustable linkage also includes fasteners extending through respective holes the second openings defined by the first and second linkage portions so as to rotatably connect a link of the accessory to the first and second linkage portions. The first and second linkage portions are separate components attached to one another by their mutual attachment to the link of the accessory.

### TECHNOLOGICAL FIELD

An example embodiment of the present disclosure relates generally to an adjustable linkage and an associated wearable accessory and, more particularly, to an adjustable linkage and an associated wearable accessory that includes a plurality of interconnected links, at least some of which include tools.

### BACKGROUND

People commonly utilize a variety of tools to perform various functions. For example, tools may be utilized for assembly or repair, such as to repair a bicycle, to assemble a newly purchased item or the like. Tools are also routinely used for even more pedestrian tasks, such as changing batteries, opening a drink, cutting open a package or the like. As such, many people desire ready access to the most commonly utilized tools, such as screwdrivers, wrenches, knives, bottle openers and the like. While people may utilize a plurality of individual tools for performing the functions described above as well as many other functions, it may be challenging to carry and have access to the plurality of individual tools when and where they may be needed. As such, multipurpose tools have been developed in order to provide a single tool that includes a plurality of tool members for performing various functions.

While multipurpose tools are advantageous in regards to the wide variety of tool members that are available, people may still be limited in regards to when they may carry a multipurpose tool. For example, people may sometimes be prevented from carrying their multipurpose tool on an aircraft or in another secure environment, such as within a school, a stadium, etc. Even if permitted to carry a multipurpose tool, people may sometime not wish to carry the multipurpose tool due to, for example, the type of clothing being worn, the activity to be undertaken or the like. As such, people may sometimes leave their multipurpose tool behind, such as when they are traveling or entering another secure environment, and therefore not have their multipurpose tool with them when they need it. Thus, the availability of multipurpose tools may also be more limited in some instances than is desired.

### BRIEF SUMMARY

An adjustable linkage is provided for a wearable accessory. The wearable accessory includes a plurality of interconnected links, at least some of which have tools. The adjustable linkage is configured to facilitate a lengthwise adjustment of the wearable accessory such that the wearable accessory may be more precisely fit to the person wearing the wearable accessory. Thus, for wearable accessories that include a functional element, such as a watch, the adjustable linkage permits the wearable accessory to be sized such that the wearable accessory remains properly oriented, such as upon a wrist of the person wearing the wearable accessory. In relation to the accommodation of the tools, the adjustable linkage of an example embodiment is configured such that a tool of one of the links that is at least partially disposed within the adjustable linkage, both remains accessible and functional when the wearable accessory is in the clasped position. In another example embodiment, the adjustable linkage is configured such that a link is permitted to rotate relative thereto such that a tool of the link extends through the adjustable linkage so as to be both accessible and functional. Thus, an adjustable linkage as well as the associated wearable accessory are configured to facilitate use of the tools of the plurality of interconnected links, thereby facilitating the functionality of the wearable accessory.

In an example embodiment, an adjustable linkage is provided for an accessory that is comprised of a plurality of links. The adjustable linkage includes first and second linkage portions spaced apart from one another to define a channel therebetween. Each of the first and second linkage portions includes a sidewall extending longitudinally between opposed first and second ends. The sidewall of each of the first and second linkage portions defines first and second openings. The second opening defined by each of the first and second linkage portions comprises a plurality of holes spaced in a longitudinal direction along the respective linkage portions. The adjustable linkage also includes fasteners extending through respective holes of the second openings defined by the first and second linkage portions so as to rotatably connect linkage a link of the accessory. The first and second linkage portions are separate components attached to one another by their mutual attachment to the link of the accessory.

An adjustable linkage of an example embodiment has a spacing between the first and second linkage portions as defined by the channel therebetween. The spacing between the first and second linkage portions is configured to be varied based upon a lateral width of the link of the accessory. In an example embodiment, each of the first and second linkage portions has an outer surface extending laterally inward from a respective sidewall and longitudinally between the opposed first and second ends. In an embodiment to which the link includes the tool, the channel defined between the first and second linkage portions is sized to be larger than the tool such that the tool is extendable between the first and second linkage portions upon rotation the link relative to the adjustable linkage. In an example embodiment, the plurality of holes of the second opening defined by each of the first and second linkage portions includes a plurality of partially overlapped holes extending in the longitudinal direction along a respective linkage portion. In an embodiment in which the adjustable linkage is configured to be rotatably connected proximate the first end to a foldable clasp mechanism that includes a tool, the tool of the foldable clasp mechanism is extendable between the first and second linkage portions upon rotation of the foldable clasp mechanism relative to the first and second linkage portions.

In another example embodiment, a wearable accessory is provided that includes a plurality of interconnected links with one or more of the links including a tool. The wearable accessory also includes an adjustable linkage including first and second linkage portions spaced apart from one another to define a channel therebetween and a foldable clasp mechanism rotatably connected to a first link of the plurality of interconnected links. The foldable clasp mechanism is configured to alternately be closed to a clasped position and opened to an open position. The first and second linkage portions are also connected to a second link of the plurality of interconnected links such that a tool of the second link is at least partially disposed within the channel defined between the first and second linkage portions as to remain accessible and functional while the foldable clasp mechanism is in the clasped position.

In an example embodiment, the first and second linkage portions are separate components attached to one another by their mutual attachment to the second link of the plurality of interconnected links. The adjustable linkage of an example embodiment has a spacing between the first and second linkage portions as defined by the channel therebetween with the spacing configured to vary based upon a lateral width of the second link of the plurality of interconnected links. In an example embodiment, the second link of the plurality of interconnected links includes a body and the second tool extended outwardly from the body. In this example embodiment, the channel defined between the first and second linkage portions is sized to be larger than the second tool of the second link such that the second tool is extendable between the first and second linkage portions upon rotation of the second link relative to the adjustable linkage.

In an embodiment in which the foldable clasp mechanism includes a tool and is rotatably connected to the adjustable linkage, the tool of the foldable clasp mechanism is extendable between the first and second linkage portions upon rotation of the foldable clasp mechanism to the open position. In this example embodiment, the tool of the foldable clasp mechanism is configured to engage another portion of foldable clasp mechanism in the clasped position in order to releasably retain the foldable clasp mechanism in the clasped position. In an example embodiment in which the tool of the second link includes an opening that serves as a bottle opener, the channel between the first and second linkage portions is sized so as not to overlap the opening that serves as the bottle opener in an instance in which the opening that serves as the bottle opener is at least partially disposed within the channel between the first and second linkage portions.

In yet another example embodiment, a functional element of a wearable accessory is provided with the functional element including a housing having opposed first and second major surfaces, a face configured to provide information to a user on the first major surface of the housing and a tool, such as a screwdriver, carried by the second major surface of the housing. In this regard, the second major surface defines a cavity configured to receive the tool as well as a recess that opens into the cavity. The tool is configured to be inserted into and retained within the recess in order to releasably secure the tool to the housing.

The housing of an example embodiment defines a notch that opens into the cavity opposite the recess. The tool of this example embodiment also defines a notch proximate the notch defined by the housing. The cavity of an example embodiment includes a floor and the recess of this example embodiment as proximate the floor of the cavity. In this example embodiment, a portion of the tool positioned opposite the recess upon insertion into the cavity defines a stepped edge portion creating a lip proximate the floor of the cavity. The housing of this example embodiment also includes an overhang that extends over a portion of the cavity opposite the recess in order to releasably secure the lip of the tool. The functional element of an example embodiment also includes a spring carried by the housing, proximate the recess and in operative engagement with a portion of the tool inserted into the recess. In this example embodiment, the spring is configured to exert a spring force upon the tool to urge the tool in the direction away from the recess.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a perspective view of a wearable accessory in accordance with an example embodiment of the present invention;

FIG. 2 is a plan view of the plurality of interconnected links in accordance with an example embodiment of the present invention;

FIG. 3 is a side view of a link defining a cross-hole that may function as a bit driver in accordance with an example embodiment of the present invention;

FIG. 4 is a plan view of the link of FIG. 3 in which the cross-hole serves as a compartment for storing a bit in accordance with an example embodiment of the present invention;

FIG. 5 is a side view of a plurality of links illustrating the manner in which a centerline of one or more of the tools lie along the centerline of the links in accordance with an example embodiment of the present invention;

FIG. 6 is a plan view of a link which illustrates the cooperative engagement of the shoulders of the links, the linkage members and the screws in accordance with an example embodiment of the present invention;

FIG. 7 is a perspective view of an adjustable linkage in accordance with an example embodiment of the present invention in which a foldable clasp mechanism is in the open position;

FIG. 8 is a perspective view of an adjustable linkage in accordance with an example embodiment of the present invention in which the foldable clasp mechanism is in the clasped position;

FIG. 9 is a side view of a linkage portion of an adjustable linkage of an alternative embodiment of the present invention in which the first and second openings proximate the first and second ends, respectively, each comprise a plurality of holes;

FIG. 10 is a plan view of the adjustable linkage of FIG. 8 illustrating the manner in which a tool is accessible via the channel defined between the first and second linkage portions in accordance with an example embodiment of the present invention;

FIG. 11 is a perspective view of a portion of a wearable accessory illustrating the manner in which the tool of an adjacent link extends through the channel defined between the first and second linkage portions in accordance with an example embodiment of the present invention;

FIG. 12 is a perspective view of a portion of a wearable accessory illustrating the manner in which the tool of the foldable clasp mechanism extends through the channel defined between the first and second linkage portions in accordance with an example embodiment of the present invention;

FIG. 13 depicts the second major surface of a functional element, such as a watch, as well as the tool carried by the functional element in accordance with an example embodiment of the present invention;

FIG. 14 is a perspective view of the second major surface of the functional element of FIG. 13 with the tool removed so as to expose the cavity defined by the housing of the functional element in accordance with an example embodiment of the present invention;

FIG. 15 is a side cross-sectional view of the recess and the cavity defined by the housing of the functional element illustrating the tool disposed therein in accordance with an example embodiment of the present invention; and

FIG. 16 is a side cross-sectional view of the tool being removed from the cavity defined by the housing of the functional element in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

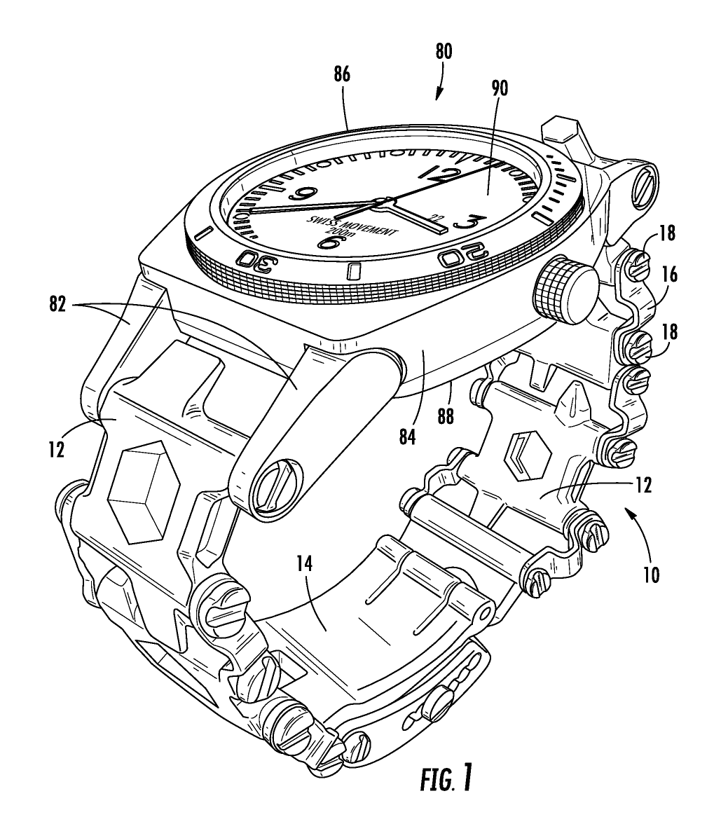

A wearable accessory 10 is provided as shown in FIG. 1. In the embodiment of FIG. 1, the wearable accessory is a watch that is configured to worn on the wrist. However, other types of wearable accessories are contemplated by and are within the scope of the present application including, by way of example but not of limitation, a bracelet worn on the wrist, but without a watch or other functional element. Alternatively, the wearable accessory may be configured to be worn in different manners, such as a necklace, an anklet, a belt, an armband or the like.

As shown in FIG. 1, the wearable accessory 10 includes a plurality of interconnected links 12 that form the band for at least partially encircling a portion of the user upon which the wearable accessory is worn, such as the wrist. In order to facilitate donning and removing the wearable accessory, the wearable accessory includes a clasp 14 that is connected to and bridges between links of the plurality of interconnected links. The clasp is configured to move between an open position in which the size of the wearable accessory is enlarged to facilitate donning or removing the wearable accessory and a clasped position as shown in FIG. 1 in which the size of the wearable accessory is reduced so as to fit more snuggly and to prevent inadvertent disengagement of the wearable accessory from the user.

The plurality of links 12 may be movably interconnected directly one to another or indirectly with other intervening members, such as decorations, non-tool links or the like, positioned therebetween. Regardless of the manner of connection, the interconnection of the links allows for limited relative movement between the links while still securing the links to one another. In the illustrated embodiment, the adjacent links are interconnected by a linkage member 16 that extends between and is rotatably connected to each of the adjacent links. Although the linkage member may be configured in various manners, the linkage member of this example embodiment may define openings at each of its two opposed ends and the links may include a fastener 18, such as a screw, a pin or the like, that extends through a respective opening defined by the linkage member and engages the body of the link. The linkage member and the links are designed such that the adjacent links are permitted to articulate, e.g., move, rotate or the like, relative to one another, while remaining mechanically connected. Thus, the fastener that secures the linkage member to a link in the illustrated embodiment may do so in a manner that maintains the mechanical connection while still permitting at least some relative movement between the adjacent links. For example, when the fastener is fully inserted into the body of the link, such as within a threaded opening defined by the body of the link, the portion of the shank of the fastener that extends between the head of the fastener and the body of the link may be at least slightly longer than the width of the linkage member such that the linkage member is retained by the fastener but is permitted to rotate relative to the link. As noted above, however, the links may be interconnected in other manners that maintain the mechanical connection between adjacent links while permitting articulation therebetween.

The plurality of links 12 are articulatable such that the plurality of links may assume different configurations. For example, the plurality of links may assume a first configuration in which the bracelet is folded flat with two layers of links lying one atop the other. The plurality of links may also assume a second configuration in which the plurality of links are curved about an axis in a first direction as shown in FIG. 1. The axis about which the links are curved may be defined by the axis that extends through the center of the wearable accessory 10, such as a bracelet, or any other axis that extends parallel thereto. For example, the axis about which a pair of adjacent links articulate, such as the axis defined by any one of the fasteners 18 that attach a linkage member 16 to a respective link, may also define the axis about which the links are curved.

The plurality of links 12 are configured to permit limited motion in a direction parallel to the axis prior to becoming structurally rigid. In this regard, the links and their respective linkage members 16 are attached to one another and are otherwise configured so as to permit limited motion in the direction of the axis, such as in the direction of an axis that extends through the center of the wearable accessory 10, such as a bracelet. However, following the limited range of motion in the direction of the axis, the plurality of links then become structurally rigid and do not permit further motion in the same direction.

The plurality of links 12 may have a curved shape and are interconnected such that a concave surface of the links faces an interior of the wearable accessory 10. In this regard, the interior surfaces of the links of the embodiment of FIG. 1 face the interior of the wearable accessory and have a concave shape. As such, the links having the concave interior surface may rest more comfortably upon the wrist of the wearer.

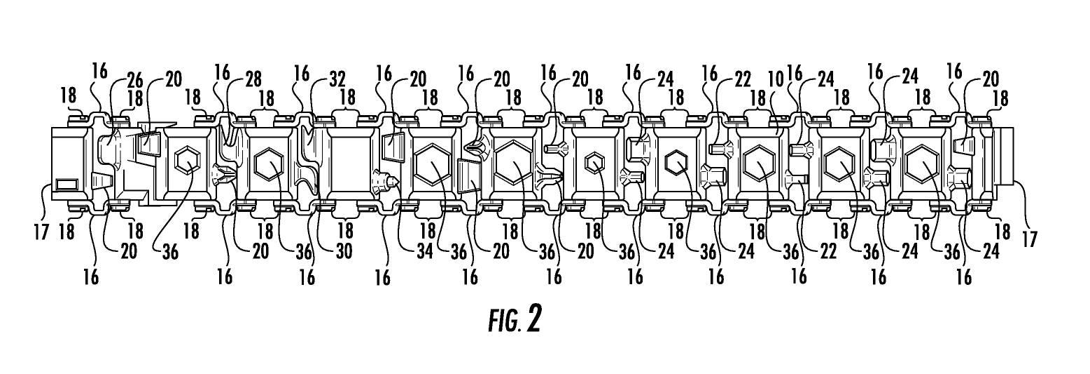

At least one link 12 and, more typically, a plurality of links, such as every link, may include at least two tools. As shown in FIG. 2, a plurality of links and the respective tools are illustrated. The plurality of links are shown in FIG. 2 without a clasp 14 and without a functional element, e.g., a watch, and in a number that exceeds the number of links typically included in a wearable accessory in order to illustrate the variety of tools that may be provided. In this regard, the plurality of links may include a variety of different tools in order to increase the utility of the wearable accessory. As shown, some tools are defined by the body of the link such as by a central portion of the link, while other tools are defined by peripheral portions of the links, such as by tools that extend outwardly from the body of the link.

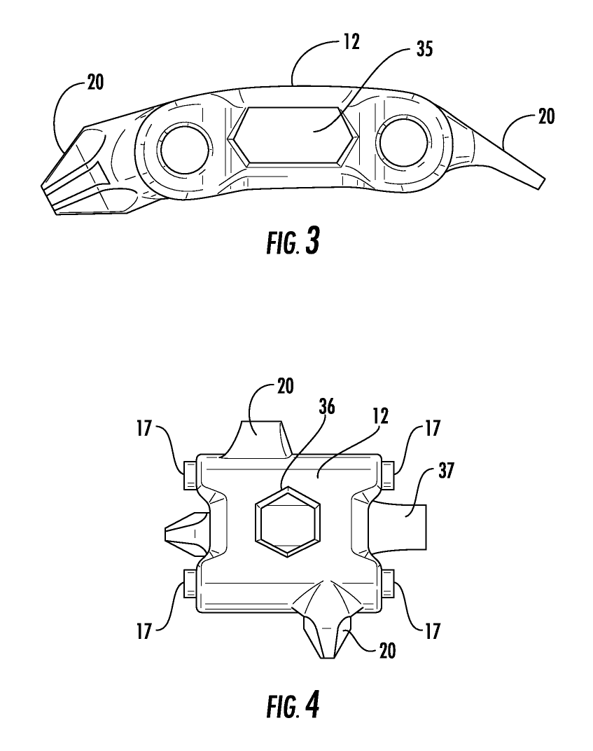

By way of example, the plurality of links 12 may include various screwdriver blades 20, including both flat screwdriver blades and Phillips screwdriver blades, of different sizes. Additionally or alternatively, the links may include one or more differently sized Robertson bits 22 and/or one or more differently sized hex keys 24. Further, one or more of the links of the illustrated embodiment may include a single sheet cutter 26, a pick 28, a cap lifter 30, a cutting hook 32 and/or a carbide scribe/glass breaker 34. Although not shown, the links may include a wide variety of other tools, such as torx drives, pozi drives or other tools. As shown in FIG. 2, each of these tools may extend outwardly from the body of a link so as to project, for example, toward an adjacent link. However, the adjacent links are positioned relative to one another, such as by being spaced from one another by the linkage members 14, so as to provide sufficient clearance therebetween such that the adjacent links may rotatably move relative to one another without contact between the tools that extend outwardly therefrom. Additionally or alternatively, the body of at least some of the links may include a tool, such as various differently sized hex wrenches 36. Although a main surface of the body of the link may include the tool, such as a hex wrench, as shown in FIG. 2, the tool may, instead, be defined by a cross-hole through a side surface of the link, an example of which is shown in FIGS. 3 and 4. The tool defined by a side surface of a link may serve, for example, as a drive socket 35 as shown in FIG. 3 or a compartment in which to house a bit 37 as shown in FIG. 4. In order to releasably secure a bit within the compartment, the bit may include an embedded nylon ball to provide sufficient friction to retain the bit within the compartment until such time that a user grasps the bit and pulls it from the compartment. The bit may be used in combination with the tool or by another tool, such as a drill, a multi-tool or the like.

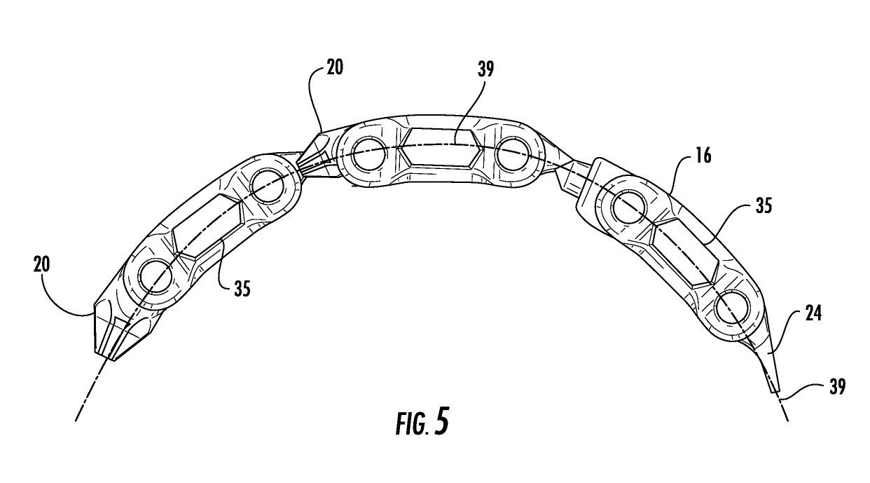

In one embodiment in which the links 12 have a curved shape and in which one or more of the links includes a screwdriver blade 20 as a tool, the screwdriver blade may have a respective tip that extends substantially tangentially from an exterior surface of a respective link, thereby following the curved shape of the respective link that carries the screwdriver blade. Indeed, as shown in FIG. 5, the centerline of the screwdriver blade including the tip of the screwdriver blade may lie substantially along the centerline 39, such as on the centerline, defined by the thickness of the plurality of interconnected links. As such, the screwdriver blade of this example embodiment will follow the same shape and contour as the links and will therefore be less likely to cause discomfort for the wearer. Similarly, other tools that extend outwardly from a respective link, such as a Robertson bit 22, a hex key 24 or the like, may also be positioned so as to extend substantially tangentially to the curved shape of the respective link and/or to have a centerline that lies substantially along the centerline, such as on the centerline, defined by the thickness of the plurality of interconnected bits.

Although a wide variety of tools are depicted in the embodiments of FIGS. 1 and 2 and are described above, the links 12 may include differently sized tools and/or different types of tools than those that are illustrated. In addition to the foregoing examples of tools that are configured to utilized to perform various mechanical tasks and as other examples of the varied types of tools that may be included, a link may include a tool in the form of a memory card, a light emitting diode (LED) light, a fire starting media, a subscriber identity module (SIM) of a mobile phone, a pedometer, a clock or a storage compartment, such as an openable, lidded storage compartment for medicine, batteries or the like. For example, two or more links may include clocks that are set to the current time in different time zones of interest to the wearer.

In addition, as the links 12 are configured to be separable, such as by removal of the fasteners 18 that connects a link to adjacent links via respective linkage members 16, the wearable accessory may be customizably designed or tailored so as to have the particular combination of tools that are desirable for a particular wearer by selecting to include certain links that have tools that are desired by the user, but omitting other links that have tools that are not as frequently utilized or are otherwise not desired by the wearer. Once the desired collection of links has been identified and ordered in the manner desired by the wearer, the links may be connected to form at least a portion of the wearable accessory, such as a bracelet, by the attachment of adjacent links, such as via respective linkage members. In this way the size of the wearable accessory, such as the bracelet, may also be customized for the wearer by including the number of links that permit the resulting bracelet to fit properly when worn. Depending upon the size of the links, the length of the bracelet may be adjusted in three quarter inch or one inch increments, for example. Additionally, the links that are chosen for inclusion within the wearable accessory, such as a bracelet, may be placed in any desired sequence since the links of an example embodiment have a common interface. Further, the links may be interconnected in either of two orientations, such as a first orientation in which a first end of the link is attached to an adjacent link and a second orientation in which a second end, opposite the first end, is attached to the adjacent link since the opposed ends of the links also have a common interface. In an example embodiment, the links may be connected and disconnected utilizing common household tools, such as a screwdriver, or by using a tool carried by the wearable accessory itself as described below such that the multi-link tool of an example embodiment is readily customizable.

In order to utilize a tool, the wearable accessory 10 may be removed by the user and positioned such that the tool to be utilized extends outwardly from the wearable accessory. The remainder of the wearable accessory may then serve as a handle for facilitating actuation of the tool. For example, the plurality of links 12 may be positioned such that a tool extends from a centrally located link with the remainder of the links extending outwardly in opposite directions therefrom so as to form a T-shaped handle. Alternatively, the plurality of links may be configured in a relatively linear manner with the tool extending from one end thereof. In either embodiment, the plurality of links may serve as a handle to facilitate actuation of the desired tool that extends outwardly therefrom for engaging a particular workpiece. Further details regarding the plurality of interconnected links and the tools carried thereby are provided by U.S. patent application Ser. No. 14/149,303 filed Jan. 7, 2014, the entire contents of which are incorporated herein by reference.

The wearable accessory 10 may be configured to have sufficient strength to permit the various tools to be utilized including, for example, sufficient strength to permit the wearable accessory to withstand the torque imposed thereupon during actuation of a screwdriver 20 or a wrench 36. The strength of the wearable accessory is derived from various aspects including the material from which the wearable accessory is formed, the size of the various components of the wearable accessory and the design and construction of the wearable accessory. Further details regarding the size and material of the various components are provided by U.S. patent application Ser. No. 14/149,303.

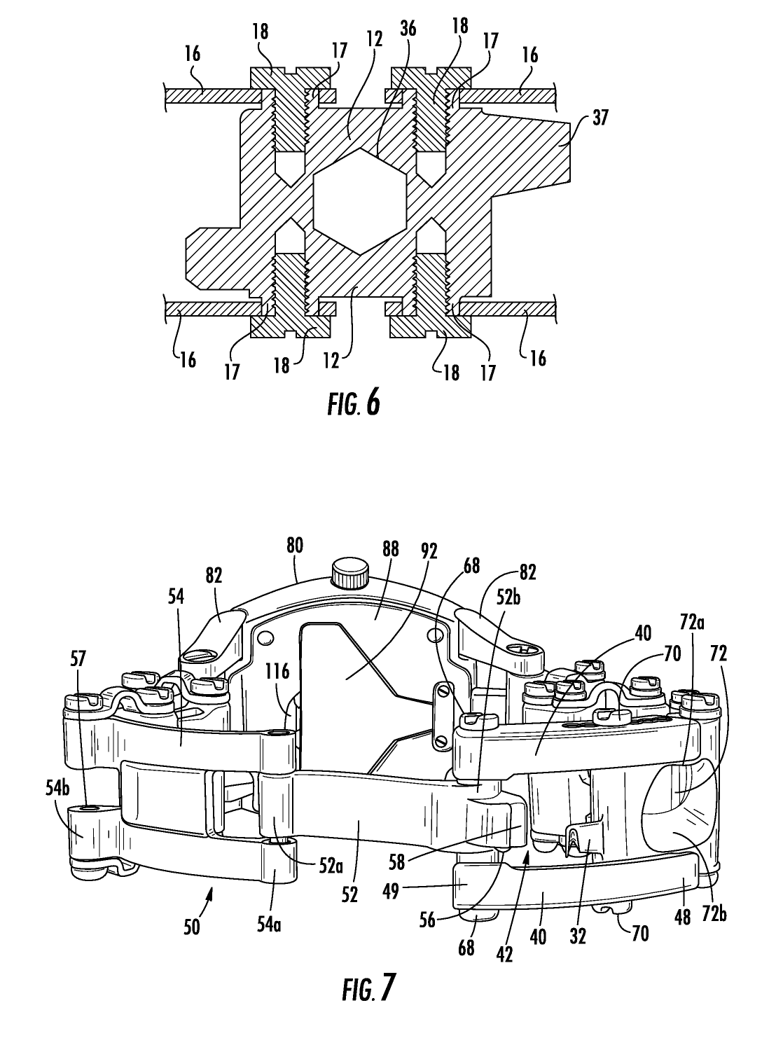

Additionally, the strength of the wearable accessory 10 is enhanced by the manner in which linkage members 16 are connected to the respective links 12. As shown in FIG. 6, each link may include a plurality of shoulders 17 that are integral with the link and that extend laterally outward from the body of the link. As shown, the link may include the same number of shoulders, e.g., four shoulders, as the number of screws 18 to be received. Each shoulder may define a threaded opening for receiving a respective screw. The linkage members cooperate with respective shoulders and the screws received by the shoulders to connect adjacent links and to provide the desired strength. In this example embodiment, the linkage members may define openings at the opposite ends. The openings defined by the linkage members and the shoulders of the links are sized such that the openings defined by the linkage members receive respective shoulders of the links. Screws may then be inserted to securely connect the links and the linkage members. The shoulders may have a height that is greater than the thickness of the linkage members so as to provide clearance between the head of the screw and the linkage member even in the typical instance in which the screw is tightened such that the head of the screw contacts the shoulder. Thus, the linkage member can permit adjacent links to move freely even in an instance in which the screw is fully tightened.

The wearable accessory 10 also includes an adjustable linkage that permits the length of the wearable accessory to be adjusted such that the wearable accessory may be sized to fit a person, such as to fit a wrist of the person, wearing the wearable accessory. Particularly in instances in which the wearable accessory includes a functional element, such as a watch, as described below, the adjustable linkage permits the wearable accessory to be sized such that the wearable accessory remains properly oriented, such as upon a wrist of the person wearing the wearable accessory. The adjustable linkage includes several components including first and second linkage portions 40 spaced apart from one another to define a channel 42 therebetween. As shown in FIG. 8, each of the first and second linkage portions includes a sidewall 44 that extends longitudinally between opposed first and second ends 48, 49. In some embodiments, each of the first and second linkage portions also include an outer surface 46 extending laterally inward from a respective sidewall and longitudinally between the first and second opposed ends. As such, although the first and second linkage portions may have various configurations, the first and second linkage portions of an example embodiment that include both sidewalls and outer surfaces have an L-shape in lateral cross-section. The first and second linkage portions may be positioned relative to one another such that the respective sidewalls are parallel to one another and face outwardly, such as in a lateral direction, away from one another. In an embodiment in which the wearable accessory is to be worn on the wrist, the first and second linkage portions may be positioned relative to one another such that the sidewall of one of the linkage portions faces the hand, while the sidewall of the other linkage portion faces the elbow.

In an embodiment in which the first and second linkage portions 40 include respective outer surfaces 46, the first and second linkage portions are also positioned relative to one another such that the respective outer surfaces lie in the same plane and face away from the user who wears the wearable accessory. As shown in FIG. 8, the first and second linkage portions may be configured so as to have an arcuate shape, such as a concave shape relative to the interior of the wearable accessory 10. By having an arcuate shape, the first and second linkage portions more easily wrap about a portion of the user, such as the wrist, upon which the wearable accessory is worn. Additionally, while the sidewall 44 and the outer surface of the linkage portions may have various sizes, the sidewall of a respective linkage portion may be somewhat larger, such as in width, than the corresponding outer surface

The clasp 14 is configured to bridge an opening between links 12 of the plurality of interconnected links and to be alternately moved between a clasped position as shown in FIG. 1 in which the wearable accessory 10 has a smaller size and an open position as shown in FIG. 7 in which the wearable accessory has a larger size. The clasp includes a foldable clasp mechanism 50 as shown in FIG. 7. Although the foldable clasp mechanism may be configured in various manners, the foldable clasp mechanism of the illustrated embodiment includes first and second clasp pieces 52, 54 that are rotatably connected to one another, such as by rotatably mounting respective first end portions 52a, 54a of the first and second clasp pieces upon an axle. The foldable clasp mechanism is configured to be moved between an open position as shown in FIG. 7 in which the first and second clasp pieces are rotated away from one another and a clasped position as shown in FIG. 1 in which the first and second clasp pieces are folded onto one another, such as with one of the clasp pieces being at least partially received within a corresponding mating depression defined by the other clasp piece. In order to releasably secure the foldable clasp mechanism in the clasped position, one of the clasp pieces may include a projection 56, such as a semispherical projection, that engages a corresponding detent or depression 57 defined by the other clasp piece. The engagement serves to releasably secure the foldable clasp mechanism in the clasped position. However, upon application of a rotational force directed so as to rotate the clasp pieces away from one another, the engagement may be overcome and the foldable clasp mechanism may rotate to the open position.

In an example embodiment, second end portions 52b, 54b of the first and second clasp pieces 52, 54 that are opposite the first end portions 52a, 54a rotatably mounted upon the axle may include the projection 56 and the corresponding detent, respectively. In the illustrated embodiment, the second end portion of the first clasp piece that includes the projection also includes a tool, such as drive member 58, e.g., a square drive, that can be utilized to perform a respective mechanical function. In this regard, the projection, such as a semispherical projection, extends from a side surface of the tool so as to engage the corresponding detent defined by the second clasp piece when the foldable clasp mechanism 50 is moved to the clasped position. In order to provide sufficient clearance between the clasp 40 and an adjacent link 12, the drive member in the form of a square drive may have a modified shape relative to a conventional square drive. For example, the end surface of the square drive may have a lip 60 along an outer surface thereof and an adjacent curved surface 62.

Although the adjustable linkage may serve to interconnect a pair of links 12 or a link and a functional element, the adjustable linkage of the illustrated embodiment interconnects a link and the foldable clasp mechanism 50. In the illustrated embodiment, the sidewall 44 of each of the first and second linkage portions 40 defines first and second openings. The first opening is proximate the first end 48, while the second opening 66 is proximate the second end 49. The adjustable linkage of this example embodiment also includes first and second fasteners 68, such as screws, pins, etc., that extend through the first openings defined by the first and second linkage portions, respectively, so as to rotatably connect the foldable clasp mechanism 50, such as the second end portion 52b of the first clasp piece 52, to the first and second linkage portions. In this regard, the second end portion of the first clasp piece can define holes that open laterally for receiving and engaging a respective fastener. For example, the holes defined by the second end portion of the first clasp piece and the first and the second fasteners may be threaded so as to be threadably engaged. Thus, the foldable clasp mechanism is connected the first and second linkage portions, while being permitted to rotate relative thereto.

The second openings 66 defined by the first and second linkage portions 40 are configured to receive third and fourth fasteners 70, respectively, so as to rotatably connect the adjustable linkage to a link 12 of the wearable accessory 10. In this regard, the link may define holes that open laterally outward for receiving and engaging the respective fastener, such as a screw, pin or the like. In one embodiment, both the third and fourth fasteners and the laterally opening holes defined by the link may be threaded so as to facilitate threaded engagement therewith. As such, the first and second linkage portions may be connected to a link while continuing to permit relative rotation there between.

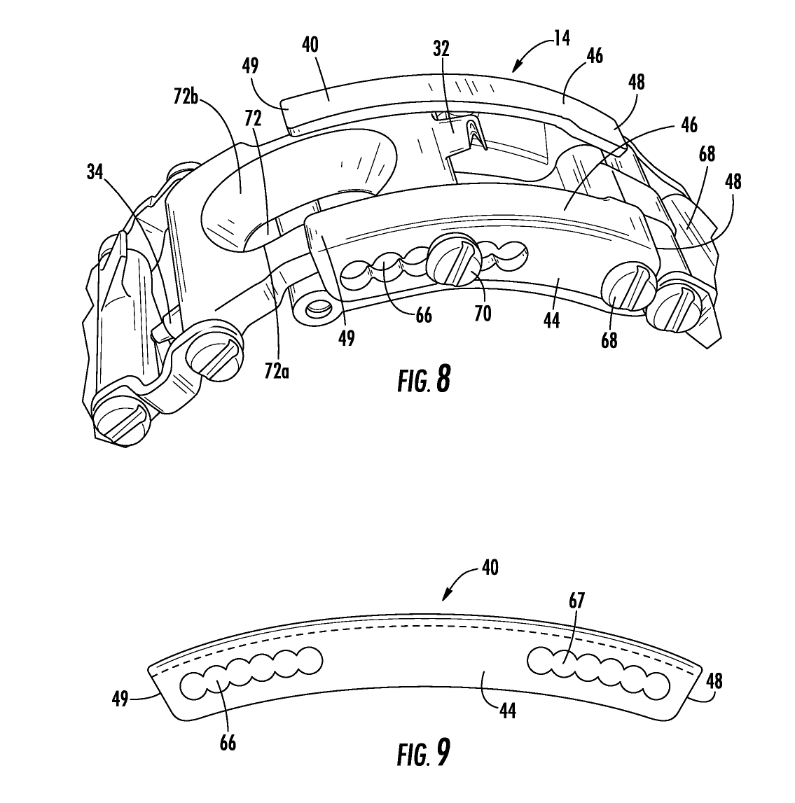

As shown in FIG. 8, the second openings 66 each include, in one example embodiment, a plurality of partially overlapped holes. The plurality of partially overlapped holes extend in a longitudinal direction from one end proximate the second end 49 of the linkage portion 40 to an opposed end within or near a medial portion of the linkage portion. By extending the respective fastener 70 through a desired one of the plurality of overlapped holes and engaging the link 12 therewith, the adjustable linkage permits the wearable accessory 10 to be sized to within the range defined by the longitudinal extent of the plurality of overlapped holes. Although the plurality of overlapped holes may provide for different amounts of adjustment, each linkage portion of the adjustable link of one embodiment includes five partially overlapped holes with a center-to-center spacing of ⅛ inch so as to provide for ⅝ inches of adjustment in ⅛ inch increments. Although shown to be partially overlapped, the second openings of another example embodiment may each include a plurality of holes that are not overlapped, but that are, instead, spaced apart from one another in the longitudinal direction. As shown in FIG. 9, the adjustable linkage of another embodiment may include first and second linkage portions having first and second openings that each include a plurality of holes, such as a plurality of overlapped holes 67, 66, such as a plurality of partially overlapped holes or a plurality of non-overlapped holes that are spaced apart from one another in the longitudinal direction, thereby permitting an even greater range of adjustability with respect to the size of the wearable accessory 10. Although the plurality of overlapped holes may provide for different amounts of adjustment, each linkage portion of the adjustable link of one embodiment includes three partially overlapped holes with a center-to-center spacing of ⅛ inch so as to provide for ¾ inches of adjustment in ⅛ inch increments. In yet another example embodiment, the sidewall of each of the linkage portions may define a plurality of partially overlapped holes or a plurality of non-overlapped holes that are spaced apart from one another in the longitudinal direction that extend across the majority of the length of the linkage portion from one end proximate the first end to the opposite end proximate the second end, thereby permitting even greater adjustability with respect to the size of the wearable accessory.

In order to complete the connection of the clasp 14 to the plurality of interconnected links 12, the second end 54b of the second clasp piece 54 of the foldable clasp mechanism 50 is also connected, either directly or indirectly, to a link. Although the second clasp piece may be directly connected to a link, the second clasp piece of the illustrated embodiment is rotatably connected to the adjacent link with linkage members 16 that permit relative movement between the clasp and the link.

As described above, the first and second linkage portions 40 are separate and independent components attached to one another indirectly by their mutual attachment to the link 12 of the wearable accessory 10 that is engaged by the third and fourth fasteners 70 and, in some embodiments, to the foldable clasp mechanism 50. As also noted above, the first and second linkage portions are spaced apart from one another to define a channel 42 that extends longitudinally therebetween. Since the first and second linkage portions are separate components, the spacing between the first and second linkage portions as defined by the channel therebetween is configured to be controllably varied based upon the lateral width of the link of the wearable accessory that is engaged by the third and fourth fasteners and, in some embodiments, by the lateral width of the foldable clasp mechanism and, in particular, the lateral width of the second end portion 52b of the first clasp piece 52. Thus, the adjustable linkage may accommodate links of different widths while utilizing the same first and second linkage portions.

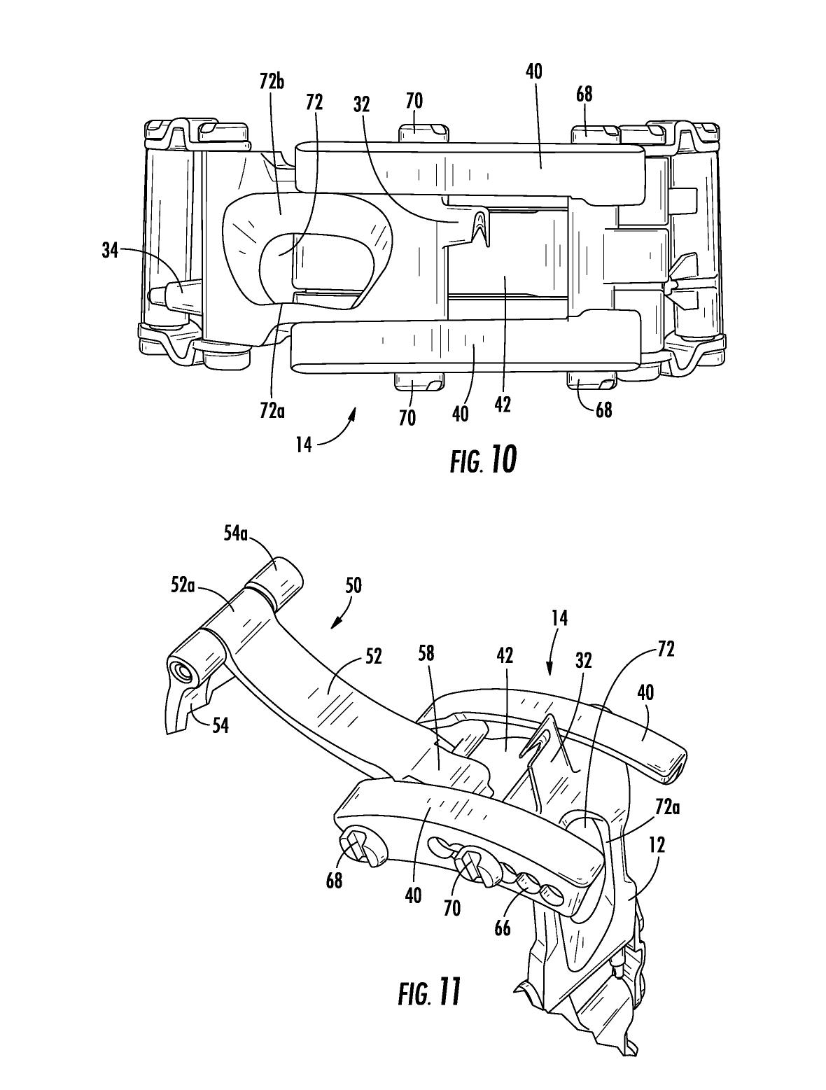

By defining the channel 42 between the first and second linkage portions 40, the link 12 that is attached to the first and second linkage portions may include one or more tools that are accessible via the channel. In an example embodiment, the tool of the link connected to the first and second linkage portions is disposed, at least partially, within the channel defined between the first and second linkage portions while the wearable accessory 10 is in the clasped position. The spacing between the first and second linkage portions provided by the channel defined therebetween is such that the tool of the link connected to the first and second linkage portions remains accessible and functional while the wearable accessory is in the clasped position. In the embodiment of FIG. 10, the tool is defined by the body of the link with the link, such as the body of the link, defining an opening 72 that serves, for example, as a bottle opener or other tool. This opening that serves as a bottle opener is fully accessible and functional while the wearable accessory is in the clasped position since the opening that defines the bottle opener is fully exposed within the channel between the first and second linkage portions.

In relation to the opening 72 that serves as the bottle opener, the opening is partially defined by an engagement edge 72a and an opposed angled surface 72b. The engagement edge directly engages the underside of a bottle cap and applies the lifting force to the bottle cap in response to relative rotation between the bottle and the link 12, while the top surface of the bottle cap is rested up and urged against the angled surface. In those embodiments that include a projection 56 for engaging a corresponding detent in order to releasably secure the first and second clasp pieces 52, 54 in the clasped position, the engagement edge of the opening that serves as the bottle opener is oppositely positioned relative to the projection with respect to the drive member 58. In other words, the engagement edge is closer to one of the linkage portions, while the projection faces and is closer (and the angled surface is also closer) to the other of the linkage portions. In an instance in which the foldable clasp mechanism 50 is in the clasped position, the relative positioning of the engagement edge with respect to the projection insures that the foldable clasp mechanism remains in the clasped position while a bottle cap is engaged by the bottle opener, since reorientation of the opening that serves as the bottle opener such that the engagement edge was closer to the same linkage portion that is faced by the projection would result in the foldable clasp mechanism being inadvertently unclasped in response to the engagement of a bottle cap by the bottle opener.

Additionally or alternatively, the link 12 connected to the first and second linkage portions 40 may include a tool that extends outwardly therefrom, such as, a cutter 32 and a glass break 34 extending outwardly from opposite ends of the link. However, other tools may alternatively extend outwardly from the link connected to the clasp portions. In the illustrated embodiment, the tool that extends outwardly from an end of the link extends in the longitudinal direction as defined by the channel 42 between the first and second linkage portions, at least once the wearable accessory 10 is in the clasped position. The tool that extends outwardly from the end of the link that is connected to the first and second linkage portions is sized, such as in lateral width, relative to the spacing between the first and second linkage portions provided by the channel such that the spacing provided by the channel is larger than the lateral width of the tool extending from the end of the link. As such, the tool that extends from the end of the link is configured to rotate through the channel and to be extendible between the first and second linkage portions so as to project outwardly therefrom as shown in FIG. 11 in response to relative rotation of the link with respect to the first and second linkage portions.

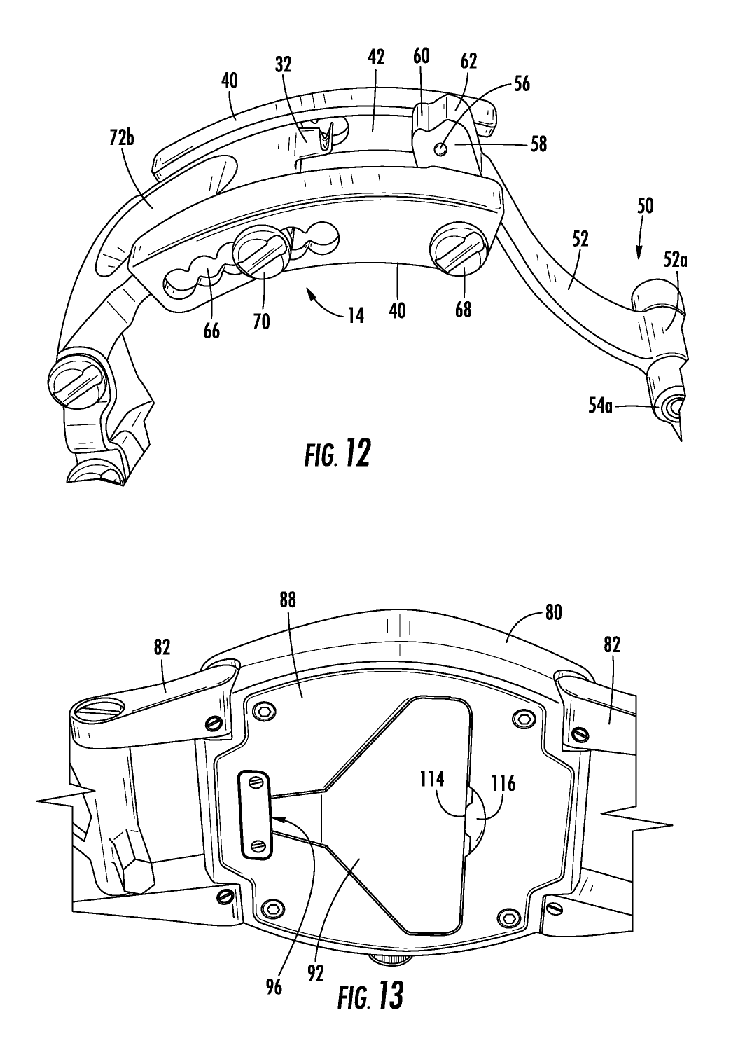

Similarly, the foldable clasp member 50 and, more particularly, the first clasp piece 52 of an example embodiment may include a tool as described above extending from the second end portion 52b of the first clasp piece that is rotatably connected to the first end 48 of the first and second linkage pieces 40. In this example embodiment, the tool carried by the foldable clasp mechanism is smaller, in lateral width, than the spacing between the first and second linkage portions provided by the channel 42. As such, the tool extending from the second end portion of the first clasp piece of the foldable clasp mechanism is able to rotate through and extend outwardly from the channel defined between the first and second linkage portions, as shown in FIG. 12.

In some embodiments, the wearable accessory 10 includes a functional element 80, such as a watch. The wearable accessory may include a wide variety of functional elements in addition to or instead of the watch. For example, other functional elements may include an exercise computer, a fitness tracker, a pedometer, a light, e.g., an light emitting diode (LED) light, a global positioning system (GPS), an electronic companion device, e.g., a smart phone, a subscriber identity module (SIM) of a mobile phone, and audio and/or video player or the like.

As shown in FIG. 1, the functional element 80, such as a watch, is connected to the plurality of interconnected links 12, such as by lugs 82 extending outwardly from opposite sides of the functional element. These lugs permit the rotatable attachment of the functional element to a respective link, such as with screws, pins or the like.

Regardless of the type of functional element 80, the functional element of an example embodiment includes a housing 84 having opposed first and second major surfaces 86, 88. In an example in which the wearable accessory 10 is worn on the wrist, the first major surface of the housing generally faces away from the wearer, while the second major surface generally faces the wearer and, in some instances, is in direct contact with the wearer. The housing may have various shapes and sizes, such as a circular, rectangular, polygonal or other shape. The functional element also has a face 90 configured to provide information to the user. The face is on the first major surface of the housing in order to face away from the wearer so as to be viewable by the wearer. The functional element may have different types of faces depending upon the function to be performed. In an embodiment in which the functional element is a watch, the face is a watch face that includes demarcations for at least some of the hours and potentially other indicia relating to minutes, day of week, etc.

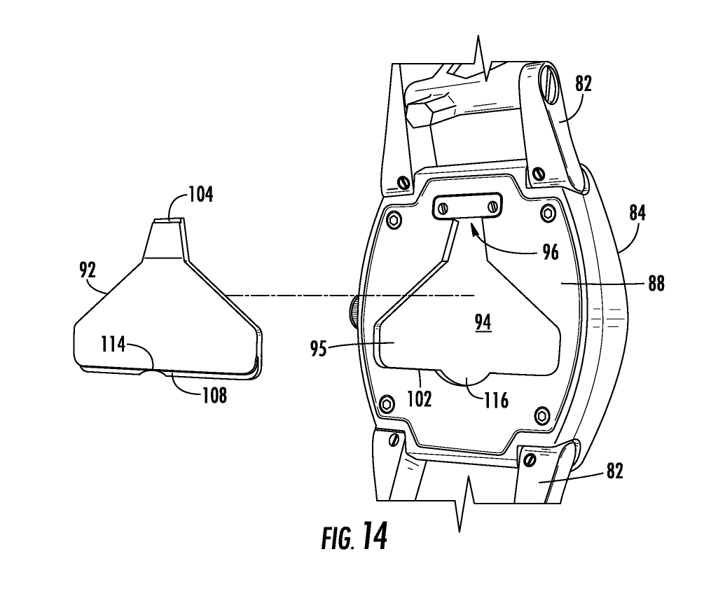

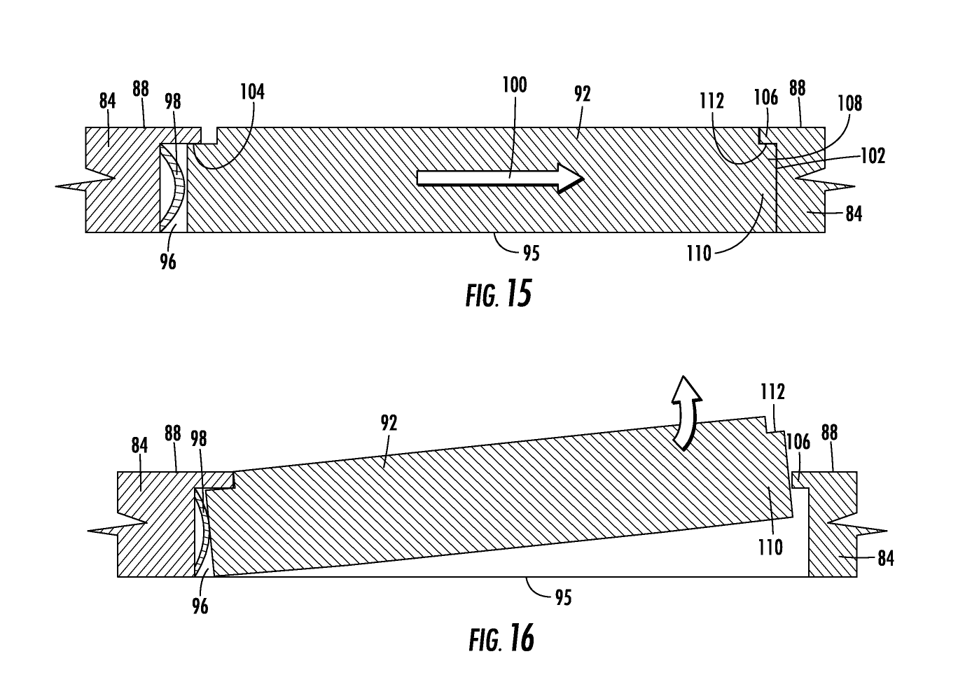

In an example embodiment, the functional element 80 also includes a tool 92 carried by the second major surface 88 of the housing 84 as shown in FIG. 13. In this regard, the second major surface defines a cavity 94 configured to receive the tool. See, for example, FIG. 14 in which the tool has been removed from the cavity. For example, the cavity may be shaped and sized so as to closely approximate the shape and size of the tool such that the tool fits snugly within the cavity with the exposed surface of the tool, in combination with the second major surface of the housing, defining a general planar surface. As shown in more detail in FIG. 15, the second major surface may also define a recess 96 that opens into the cavity. As such, a portion of the tool is configured to be inserted into and retained within the recess in order to releasably secure the tool to the housing.

The functional element 80 may include a variety of different types of tools 92. In an example embodiment, however, the tool is a screwdriver that is sized to engage the fasteners 18 that are utilized to connect the linkage members 16 to the links 12. Thus, the wearable accessory 10 is self-contained in that the tool required to assemble and disassemble the plurality of links, such as to remove, replace or add links to the wearable accessory, is carried by the wearable accessory itself. In some embodiments, the tool may include additional tool functionality, such as a nail file.

In the illustrated embodiment, the housing 84 defines a recess 96 opening into the cavity 94. While the cavity opens outwardly through the second major surface 88 of the housing, the recess does not similarly open outwardly through the second major surface and, instead, is proximate the floor 95 of the cavity and opens only into the cavity itself. Upon insertion of the tool 92 into the cavity, a portion of the tool, such as the distalmost tip of the screwdriver in the illustrated embodiment, is inserted into the recess with the remainder of the tool then being placed into the cavity. Thus, the majority of the tool is exposed within the cavity, but that portion of the tool that is inserted in the recess is hidden from view.

In order to releasably secure the tool 92 within the cavity 94, the functional element 80 of an example embodiment also includes a spring 98 carried by the housing 84 and proximate the recess 96. As shown in FIG. 15, the spring may be disposed within the housing and may open into or otherwise be in operative engagement with the portion of the recess that is furthest from the cavity 94. As such, the spring may provide a spring force to the tool upon insertion of a portion of the tool into the recess. The spring is configured to provide the spring force so as to urge the tool outward from the recess into the cavity in a direction 100 generally parallel to the second major surface 88 of the housing. The tool, the recess and the cavity are sized, however, such that the spring force does not cause the tool to be disengaged from the recess with the tool, instead, being positioned by the spring force so as to abut the wall 102 of the cavity that is positioned opposite the recess while a portion of the tool remains within the recess. In an example embodiment, the portion of the tool that is inserted into the recess may include a recessed outer edge 104. As such, the remainder of the edge that is inserted into the recess may be sized to appropriately fit within the recess with the remainder of the tool that is outside of the recess remaining generally co-planar with the second major surface of the housing.

In order to further engage the tool 92 in the cavity 94, at least one wall of the cavity, such as the wall 102 of the cavity that is opposite the recess 96, includes, in one example embodiment depicted in FIG. 15, an overhang 106 in order to engage the corresponding edge of the tool that abuts therewith. In this regard, the overhang includes a portion, such as a portion that is co-planar with the second major surface 88 of the housing 84, that extends over a portion of the cavity with the portion of the cavity thereby underlying the overhang. In this example embodiment, the tool may also include an edge that abuts the wall having the overhang that includes a stepped edge portion 108. The stepped edge portion is configured with an outwardly extending lip 110 along the side of the tool that faces and is proximate to the floor 95 of the cavity and a corresponding recessed edge 112 along the side of the tool that faces away from the floor of the cavity. The recessed edge is sized to correspond to the size of the overhang with the outwardly extending lip of the tool being urged by the spring force into that portion of the cavity that underlies the overhang such that the overhang mates with and is received within the recessed edge of the tool. By urging the outwardly extending lip of the tool under the overhang with the spring force while continuing to retain a portion of the tool within the recess, the tool is releasably retained within the cavity defined by the housing.

As such, in order to insert the tool 92 into the cavity 94 and to retain the tool therewithin, a portion of the tool, such as a screwdriver blade in the illustrated embodiment, is inserted into the recess 96 and the remainder of the tool is disposed within the cavity. The spring force then urges the tool as shown in FIG. 15 in a direction 100 away from the recess such that the stepped edge portion 108 of the tool, opposite the recess, is engaged by the overhang 106 while a portion of the tool remains within the recess such that the tool is releasably secured within the cavity. In order to remove the tool from the cavity, the tool is urged by a user in a direction toward the recess so as to overcome the spring force. Once the tool has been urged sufficiently in the direction toward the recess such that the stepped edge portion of the tool no longer engages the overhang, the stepped edge portion may be lifted from the cavity and the tool then withdrawn from the cavity as shown in FIG. 16.

In order to facilitate the removal of the tool 92 from the cavity 94, the tool may define a notch 114, such as along the stepped edge portion 108 of the tool, to facilitate the engagement of the tool by a user, such as with the fingernail of a user. Correspondingly, the housing 84, such as the second major surface 88 of the housing, may also define a notch 116 in alignment with the notch defined by the tool to facilitate insertion of the user's fingernail into engagement with the notch of the tool in order to remove the tool from the cavity. As such, a tool may be releasably carried by the functional element 80 in order to perform various mechanical functions, such as a screwdriver to engage the various fasteners 18 with which the plurality of links 12 and the linkage members 16, including the adjustable linkage, are connected, thereby providing for a self-contained unit that is readily able to be modified, such as by the removal of links, the insertion of links or the like.

As described above, at least one of the links 12 may include at least two tools and, in one embodiment, many of the links may include one or more tools such that the wearable accessory 10 has many types of tools and many differently sized tools, thereby increasing the utility of the wearable accessory. Moreover, by being configured as a wearable accessory and by the selection of the tools to provide the desired functionality without including a prohibited item, such as a knife, the multi-link wearable accessory may be carried in a wider range of situations, including on board an aircraft or in other secure environments. Thus, the wearable accessory of an example embodiment may facilitate the availability of the tools provided by the links of the wearable accessory.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An adjustable linkage for an accessory comprised of a plurality of links, the adjustable linkage comprising:
first and second linkage portions spaced apart from one another to define a channel therebetween, wherein each of the first and second linkage portions comprises a sidewall extending longitudinally between opposed first and second ends, and wherein the sidewall of each of the first and second linkage portions defines first and second openings, and wherein the second opening defined by each of the first and second linkage portions comprises a plurality of holes spaced in a longitudinal direction along the respective linkage portions; and
fasteners extending through respective holes of the second openings defined by the first and second linkage portions so as to rotatably connect a link of the accessory to the first and second linkage portions,
wherein the first and second linkage portions are separate components attached to one another by their mutual attachment to the link of the accessory.

2. An adjustable linkage according to claim 1 wherein a spacing between the first and second linkage portions as defined by the channel therebetween is configured to be varied based upon a lateral width of the link of the accessory.

3. An adjustable linkage according to claim 1 wherein each of the first and second linkage portions has an outer surface extending laterally inward from a respective sidewall and longitudinally between the opposed first and second ends.

4. An adjustable linkage according to claim 1 wherein the link includes a tool, and wherein the channel defined between the first and second linkage portions is sized to be larger than the tool such that the tool is extendible between the first and second linkage portions upon rotation of the link relative to the adjusatable linkage.

5. An adjustable linkage according to claim 1 wherein the plurality of holes of the second opening defined by each of the first and second linkage portions comprises a plurality of partially overlapped holes extending in the longitudinal direction along a respective linkage portion.

6. An adjustable linkage according to claim 1 configured to be rotatably connected proximate the first end to a foldable clasp mechanism that includes a tool, and wherein the tool of the foldable clasp mechanism is extendible between the first and second linkage portions upon rotation of the foldable clasp mechanism relative to the first and second linkage portions.

7. A wearable accessory comprising:
a plurality of interconnected links, wherein one or more of the links includes a tool; and
an adjustable linkage comprising first and second linkage portions spaced apart from one another to define a channel therebetween; and
a foldable clasp mechanism rotatably connected to linkage a first link of the plurality of interconnected links, wherein the foldable clasp mechanism is configured to alternately be closed to a clasped position and opened to an open position,
wherein the first and second linkage portions are also connected to a second link of the plurality of interconnected links such that a tool of the second link is at least partially disposed within the channel defined between the first and second linkage portions so as to remain accessible and functional while the foldable clasp mechanism is in the clasped position.

8. A wearable accessory according to claim 7 wherein the first and second linkage portions are separate components attached to one another by their mutual attachment to the second link of the plurality of interconnected links.

9. A wearable accessory according to claim 8 wherein a spacing between the first and second linkage portions as defined by the channel therebetween is configured to be varied based upon a lateral width of the second link of the plurality of interconnected links.

10. A wearable accessory according to claim 7 wherein the second link of the plurality of interconnected links comprises a body and a second tool extending outwardly from the body, wherein the channel defined between the first and second linkage portions is sized to be larger than the second tool of the second link such that the second tool is extendible between the first and second linkage portions upon rotation of the second link relative to the adjustable linkage.

11. A wearable accessory according to claim 7 wherein the foldable clasp mechanism includes a tool and is rotatably connected to the adjustable linkage, wherein the tool of the foldable clasp mechanism is extendible between the first and second linkage portions upon rotation of the foldable clasp mechanism to the open position, and wherein the tool of the foldable clasp mechanism is configured to engage another portion of the foldable clasp mechanism in the clasped position in order to releasably retain the foldable clasp mechanism in the clasped position.

12. A wearable accessory according to claim 7 wherein the tool of the second link comprises an opening that serves as a bottle opener, and wherein the channel between the first and second linkage portions is sized so as not to overlap the opening that serves as the bottle opener in an instance in which the opening that serves as the bottle opener is disposed within the channel between the first and second linkage portions.

13. A functional element of a wearable accessory, the functional element comprising:
a housing having opposed first and second major surfaces;
a face configured to provide information to a user on the first major surface of the housing; and
a tool carried by the second major surface of the housing, wherein the second major surface defines a cavity configured to receive the tool as well as a recess that opens into the cavity, and wherein the tool is configured to be inserted into and retained within the recess in order to releasably secure the tool to the housing.

14. A functional element according to claim 13 wherein the cavity includes a floor, and wherein the recess is proximate the floor of the cavity.

15. A functional element according to claim 14 wherein a portion of the tool positioned opposite the recess upon insertion into the cavity defines a stepped edge portion that creates a lip proximate the floor of the cavity.

16. A functional element according to claim 15 wherein the housing includes an overhang that extends over a portion of the cavity opposite the recess in order to releasably engaged the lip of the tool.

17. A functional element according to claim 13 wherein the housing defines a notch that opens into the cavity opposite the recess, and wherein the tool also defines a notch proximate the notch defined by the housing.

18. A functional element according to claim 13 further comprising a spring carried by the housing, proximate the recess and in operative engagement with a portion of the tool inserted into the recess.

19. A functional element according to claim 18 wherein the spring is configured to exert a spring force upon the tool to urge the tool in a direction away from the recess.

20. A functional element according to claim 13 wherein the tool comprises a screwdriver.
